(19) United States
(12) Patent Application Publication
(10) Pub. No.: US 2010/0297498 A1
(43) Pub. Date: Nov. 25, 2010

(54) PLASTICIZED ELECTRODE FOR AN ALKALINE SECONDARY CELL

(75) Inventors: Patrick BERNARD, Bordeaux (FR); Lionel GOUBAULT, Carigan de Bordeaux (FR); Stephane GILLOT, Ambares (FR); Thierry FEUGNET, Angouleme (FR)

Correspondence Address: SUGHRUE MION, PLLC, 2100 PENNSYLVANIA AVENUE, N.W., SUITE 800, WASHINGTON, DC, 20037, US

(73) Assignee: SAFT GROUPE SA, Bagnolet (FR)

(21) Appl. No.: 12/772,677

(22) Filed: May 3, 2010

(30) Foreign Application Priority Data
May 19, 2009 (FR) 09 02 422

(51) Int. Cl. H01M 4/62; H01M 4/04

(52) U.S. Cl. 429/217; 427/58

(57) ABSTRACT

There are provided a non-sintered positive electrode for an alkaline secondary cell comprising a current conductive support and a paste comprising an electrochemically active material and a binder comprising at least one polymer a) other than a fluorinated polymer or a thickener and containing at least one acrylate or acetate function, in a weight percentage less than or equal to 1% of the weight of the paste, at least one fluorinated polymer b), in a weight percentage of from 0.5 to 4% of the weight of the paste and at least one thickener c) in a weight percentage less than or equal to 0.3% of the weight of the paste, and a method of producing a non-sintered electrode.

### FIELD OF THE INVENTION

The present invention is in the field of plasticized positive electrodes for alkaline electrolyte secondary cells, for example of the NiCd, NiMH or NiZn type. The invention also relates to the field of methods for preparing plasticized positive electrodes for an alkaline electrolyte secondary cell (electrochemical generator).

### BACKGROUND ART

Non-sintered electrodes, also called plasticized electrodes, generally comprise a current conductive support on to which a paste comprising an electrochemically active material is deposited by coating. Nickel non-sintered electrodes generally employ a high porosity (greater than 90%) three-dimensional conductive support, of the nickel foam or felt type. When the cost per component of a conventional positive electrode is analyzed, it is seen that the support for the positive electrode makes up more than 50% of the cost of the electrode.

A non-sintered positive electrode including an inexpensive current conductive support has been developed in order to reduce secondary cell costs. This electrode employs a two-dimensional conductive support of the perforated foil type, and a paste comprising an electrochemically active material based on nickel hydroxide, a conductive compound and a binder.

This binder is an essential component of the electrode as its function is to guarantee cohesion of the grains of active material both between themselves and to the electrode support, prior to assembling the secondary cell, and during its operation. The binder must be adhesive with respect to the active material and the metallic support, and be sufficiently flexible and elastic to be able to accommodate the deformations encountered when the secondary cell is being produced. It must also have sufficient chemical stability as regards the highly basic alkaline electrolyte, and must be capable of withstanding electrochemical oxidation by oxygen generated at the end of secondary cell charging. Indeed, the oxidation reaction of the binder generates carbonates in the electrolyte, which leads to deterioration of secondary cell performance. In parallel this reaction brings about, on the other hand, a reduction reaction at the negative electrode. This results in the oxidation of the binder creating a decrease in the excess negative capacity in proportion to the quantity of electrons generated by the binder oxidation reaction. When the negative capacity excess falls to zero, the negative electrode generates gaseous hydrogen during charging, and pressure in the cell increases until the safety valve opens. This is followed by a drying up and the end of the secondary cell life.

The polytetrafluoroethylene (PTFE) employed as a binder in traditional positive electrodes totally withstands oxidation. This polymer is however not sufficiently adhesive and flexible to provide plasticized positive electrodes on a two-dimensional current conductive support. Novel solutions have been developed for resolving the problem of the mechanical behavior of non-sintered positive electrodes.

One solution disclosed in FR-A-2,906,083 consists in employing a mixture of a copolymer of ethylene and vinyl acetate (EVA) and a cellulosic compound. EVA has excellent adhesive properties. It is sufficient to add a small quantity, in other words less than 1% by weight compared to the total dry matter weight of material deposited on the current conductive support, in order to obtain excellent cohesion of the active material. The cellulosic compound is generally employed for its thickening properties, essential for producing the paste, but it also makes it possible to improve cohesion between the nickel hydroxide particles. These binders do not totally resist oxidation in the positive electrode, but the amount of carbonates generated is sufficiently small to obtain satisfactory lifetime. Nevertheless, recent measurements have demonstrated that self discharge of these cells increases considerably in applications where the temperature is elevated (T>40° C.). Indeed, after oxidation, the binders are no longer in a position to ensure electrode cohesion and conducting particles of active material migrate into the separator, generating micro-short circuits. In this case, self discharge of the secondary cell can be sufficiently high to lead to unsuitability for the application.

European patent application EP-A-0,930,663 discloses a non-sintered positive electrode containing a conductive support and a paste comprising an electrochemically active material and a binder; this binder comprising:
an elastomer chosen from a copolymer of styrene, of ethylene, of butylene and of styrene (SEBS), a terpolymer of styrene, of butadiene and of vinylpyridine and copolymer of styrene and of butadiene making up at least 25% by weight of the binder mixture;
and a crystalline polymer chosen from a fluorinated polymer and a polyolefin.

French patent application FR-A-2,824,187 provides a non-sintered positive electrode comprising a metallic conductive support and a paste comprising an electrochemically active material and a binder; this binder comprising:
an elastomer constituted by a butadiene polymer
and a copolymer of ethylene and vinyl acetate.

French patent application FR-A-2,851,081 provides a non-sintered positive electrode that includes a two-dimensional support covered with a layer containing a binder characterized in that the said binder is a mixture of a styrene-acrylate copolymer and a cellulosic compound selected from the group comprising carboxymethylcellulose (CMC), hydroxypropylmethyl-cellulose (HPMC), hydroxypropylcellulose (HPC) and hydroxyethylcellulose (HEC).

Patent FR-A-2,899,018 claims plasticized positive electrode comprising a metallic conductive support and a paste comprising an electrochemically active material and a binder; this binder comprising:

a) a compound of the silane type,

b) a polymer comprising at least one acrylic monomer, and representing at least 0.15% of the weight of said paste.

Alkaline secondary cells of the NiCd or NiMH type comprising, as their positive electrodes, sintered electrodes or electrodes with a three-dimensional support of the foam or felt type are commercially available. The problem of stability of performance or of self discharge stability is much less pronounced with this type of electrode than with non-sintered electrodes with a two-dimensional support.

It is also known to use non-sintered positive electrodes on inexpensive supports, which are generally metallic supports which have been shaped three-dimensionally or which exhibit very high surface roughness allowing adhesion of the active material. We can cite the scientific article published in the Journal of the Electrochemical Society (152, 5 (2005) A 905-A 912) which discusses the performance of a NiMH secondary cell positive electrode comprising a three-dimensional nickel steel foil and a styrene-acrylate type binder. The lifetime of this secondary cell is 1000 cycles at 25° C. but only 180 cycles at 45° C. as a result of the styrene-acrylate decomposition. Replacing styrene-acrylate by a styrene maleic anhydride (SMA) type binder makes it possible to obtain a lifetime of 800 cycles at 45° C.

Japanese patent document JP 3,165,469 discloses a nickel electrode comprising a porous two-dimensional conductive support such as a grid, and an expanded metal or a perforated metal, covered with a paste including nickel hydroxide, a conductive material and a thermoplastic binder such as a butylene/ethylene/styrene copolymer.

European patent application EP-A-0,750,358 discloses a non-sintered nickel electrode whose support is a corrugated metal plate on which asperities are formed to attach a layer which is rough on a microscopic scale and is made up of powdered nickel and/or cobalt bound with butadiene-polyvinyl alcohol PVAI. Onto this layer is deposited a paste comprising carboxymethylcellulose CMC and a styrene/butadiene copolymer SBR.

Japanese patent application JP-A-53,074,247 relates to a nickel electrode containing as an active material, a nickel compound, for example a hydroxide, a conductive material such as graphite flakes and a binder. The binder is a mixture of polystyrene and either a copolymer of ethylene and vinyl acetate or a styrene/butadiene copolymer.

Japanese patent document JP 11-135,112 provides a positive electrode made up of a foil including asperities, a metallic or carbon powder (1-15%), cobalt powder or cobalt oxide (1-15%), active material and 0.5 to 5% of a fluorinated resin as the binder.

There is a need for an alkaline electrolyte secondary cell having a positive non-sintered nickel electrode employing a metallic support other than foam or felt, a limited quantity of binder, and having a low self-discharge rate as well as a high electrochemical capacity, throughout the lifetime of the secondary cell in the application.

There is also a need for a method for producing a non-sintered electrode providing improved adhesion of the electrochemically active material to the current collecting support.

### SUMMARY OF THE INVENTION

The invention provides a non-sintered positive electrode for an alkaline secondary cell comprising a current conductive support and a paste comprising an electrochemically active material and a binder; the binder comprising:
at least one polymer a) other than a fluorinated polymer or a thickener and containing at least one acrylate or acetate function, in a weight percentage less than or equal to 1% of the weight of the paste;
at least one fluorinated polymer b), in a weight percentage of from 0.5 to 4% of the weight of the paste;
at least one thickener c) in a weight percentage less than or equal to 0.3% of the weight of the paste.

According to one embodiment, the weight percentage of polymer a) is from 0.1 to 1%, preferably from 0.3 to 0.9% of the weight of the paste.

According to another embodiment, the weight percentage of the fluorinated polymer b) is from 0.1 to 4%, preferably from 1 to 3% of the weight of the paste.

According to one embodiment, the weight percentage of the thickener c) is from 0.01 to 0.3%, preferably from 0.05 to 0.25% of the weight of the paste.

According to another embodiment, the polymer a) is selected from the group comprising a copolymer of ethylene and vinyl acetate (EVA), a copolymer of styrene and acrylate, a polyacrylate, or a mixture thereof.

According to another embodiment, the polymer a) is selected from the group consisting of a copolymer of ethylene and vinyl acetate (EVA), a copolymer of styrene and acrylate, a polyacrylate, or a mixture thereof.

According to another embodiment, the fluorinated polymer is selected from the group comprising polytetrafluoroethylene (PTFE), a fluorinated ethylene/propylene (FEP) copolymer, hexafluoropropylene (HFP), or a mixture thereof. Preferably, polytetrafluoroethylene (PTFE) is selected.

According to one embodiment, the thickener is cellulosic polymer selected from the group comprising carboxymethylcellulose (CMC), hydroxypropylmethylcellulose (HPMC), hydroxypropylcellulose (HPC), hydroxyethylcellulose (HEC), or is a polymer of the poly acrylic acid (PAAC) type or is a xanthane gum or a mixture thereof.

The electrode can further comprise silane of general formula X—Si(OR)₃, R being able to be selected from the group comprising methyl, ethyl, isopropyl, cyclohexyl or phenyl groups; and X being able to be selected in the group comprising epoxy, amine, styrylamine, methacrylate, vinyl, chloroalkyl groups.

In one embodiment, R is a methyl group and X is an epoxy group. According to another embodiment, the silane is of the 3-glycidoxypropyltrimethoxy-silane type.

According to one embodiment, the weight percentage of silane with respect to the weight of paste is less than 0.5%, preferably from 0.05 to 0.25%.

According to one embodiment, the binder solely comprises:

a) a copolymer of ethylene and vinyl acetate (EVA), or a copolymer of styrene and acrylate, or a polyacrylate, or a mixture thereof;

b) a fluorinated polymer;

c) a thickener.

According to one embodiment, the current conductive support is selected from the group comprising a non-perforated or perforated foil, an expanded metal, a grid.

According to another embodiment, the conducting support has a thickness, in the non-perforated region, less than about 0.1 mm.

According to one embodiment the electrode further includes from 5 to 20% by weight of the paste of a conductive material, preferably from 5 to 15% by weight of the paste.

According to another embodiment, the paste contains a compound based on yttrium, ytterbium, niobium or strontium.

According to a further embodiment, the electrode further includes fibers.

This electrode can be advantageously used as a positive electrode in an alkaline secondary cell of the NiCd, NiMH or NiZn type. The combination of the components a), b) and c) in the proportions given above makes it possible to obtain an electrode having the following properties:
a low self-discharge rate along with high electrochemical capacity throughout the lifetime of the secondary cell,
good mechanical performance or stability.

The invention further provides an alkaline electrolyte secondary cell comprising an electrode according to the invention.

Finally, the invention provides a method for producing a non-sintered electrode comprising the steps of:

a) preparing a mixture comprising:
an electrochemically active material,
at least one polymer other than a fluorinated polymer or a thickener,
a thickener,
water;

b) forming a paste;

c) adding a fluorinated polymer to the paste obtained at step b);

d) depositing the paste obtained at step c) on a conductive support;

e) drying the electrode.

According to one embodiment, the polymer of step a) other than a fluorinated polymer or a thickener, contains a least one acrylate or acetate function.

According to an embodiment, in step c), the fluorinated polymer is added to the paste in the form of an aqueous solution.

This method is especially suitable for producing the electrode according to the invention. Further, the fact of adding the fluorinated polymer separately from the other constituents of the binder makes it possible to limit interactions between this fluorinated polymer and the other constituents of the binder. By virtue of the absence of interaction between this fluorinated polymer and the other constituents of the binder, the electrode obtained has enhanced mechanical stability.

### BRIEF DESCRIPTION OF THE DRAWING

FIG. 1 is a view in cross-section of a perforated foil the thickness of which is less than or equal to 100 μm in the non-perforated region, and of which the peak-to-peak thickness in the perforation region is greater than the thickness of the non-perforated region, for example 200 μm.

### DETAILED DESCRIPTION OF PREFERRED EMBODIMENTS

The electrode according to the invention comprises a current conductive support and a paste comprising an electrochemically active material and a binder. The binder comprises the following constituents:
at least one polymer a) other than a fluorinated polymer or a thickener, and containing at least one acrylate or acetate function, in a weight percentage less than or equal to 1% of the weight of the paste;
at least one fluorinated polymer b), in a weight percentage of from 0.5 to 4% of the weight of the paste;
a least one thickener c) in a weight percentage less than or equal to 0.3% of the weight of the paste.

The polymer a) can be selected from the group comprising a copolymer of ethylene and vinyl acetate (EVA), a copolymer of styrene and acrylate, a polyacrylate, or a mixture thereof.

Preferably, the weight percentage of polymer a) is from 0.1 to 1%, preferably from 0.3 to 0.9% of the weight of the paste. Preferably, polymer a) is an ethylene-vinyl acetate copolymer in which the percentage by weight of the acetate group makes up 40-95% of the copolymer weight.

The fluorinated polymer b) can be selected from the group comprising polytetrafluoroethylene (PTFE), a fluorinated ethylene/propylene (FEP) copolymer, hexafluoropropylene (HFP), preferably polytetrafluoroethylene (PTFE) or a mixture thereof. Preferably, the weight percentage of polymer b) is from 1 to 4%, more preferably from 1 to 3% by weight of the paste.

The thickener c) can be selected from the group of cellulosic polymers such as carboxymethylcellulose (CMC), hydroxypropylmethylcellulose (HPMC), hydroxypropylcellulose (HPC), hydroxyethylcellulose (HEC), or a mixture thereof. It can also be a polymer of the poly acrylic acid (PAAC) type or is a xanthane gum. Preferably, the weight percentage of thickener c) is from 0.05 to 0.25% of the weight of the paste.

In a preferred embodiment, the binder solely comprises:
a) a copolymer of ethylene and vinyl acetate (EVA), or a copolymer of styrene and acrylate, or a polyacrylate, or a mixture thereof;
b) a fluorinated polymer;
c) a thickener.

The binder can also comprise a compound of the silane type of general formula

X—Si(OR)₃, R being able to be selected from the group comprising methyl, ethyl, isopropyl, cyclohexyl or phenyl groups and X being able to be selected in the group comprising epoxy, amine, styrylamine, methacrylate, vinyl, chloroalkyl groups. Preferably, R is a methyl group and X is an epoxy group. In a preferred embodiment, the silane is of the 3-glycidoxypropyltrimethoxy-silane type. Generally, the weight proportion of the silane with respect to the weight of the paste is less than 0.5%, preferably from 0.05 to 0.25%.

All these polymers are readily soluble in water or are available in aqueous dispersion, which facilitates production of the electrodes by application of wet paste, followed by drying.

The electrochemically active material is preferably a nickel-based hydroxide. By a “nickel-based hydroxide” we mean a nickel hydroxide, a hydroxide principally containing nickel, but also a nickel hydroxide containing at least one syncrystallised hydroxide of an element selected from zinc (Zn), cadmium (Cd), magnesium (Mg) and aluminum (Al), and at least one syncrystallised hydroxide of an element selected from cobalt (Co), manganese (Mn), aluminum (Al), yttrium (Y), calcium (Ca), zirconium (Zr), and copper (Cu). A syncrystallised hydroxide contained in the nickel hydroxide is a hydroxide forming a solid solution with the nickel hydroxide, in other words occupying, in a continuously variable proportion, atomic sites defined by the crystalline lattice of the nickel hydroxide.

Preferably, this hydroxide has a spheroidal form and has a particle size comprised between 7 and 25 μm. The nickel hydroxide can preferentially be covered with a coating based on cobalt hydroxide, optionally partially oxidized, or associated with a conducting compound, principally constituted by Co(OH)₂. Other compounds such as Co, CoO, LiCoO₂, metallic powders, carbons, ZnO, Y₂O₃, Yb₂O₃, Nb₂O₃, SrSO₄, Sr(OH)₂ can be added to the active material. In one embodiment, the paste comprises from 5 to 20% conductive material, preferably from 5 to 15% by weight of the paste.

There can be incorporated into the paste a compound of yttrium, ytterbium, niobium or strontium in a weight percentage generally less than 1% of the weight of the paste.

Conducting or non-conducting fibers can also be incorporated into the paste. Preferably, the amount of fibers added is less than 1.5% of the weight of the paste.

Preferably, these are polymer fibers of polypropylene for example, of a diameter comprised between 10 and 35 μm and of a length less than 2 mm.

In a first step, there are mixed the electrochemically active material, the additives such as the conducting material and the constituents of the binder with the exception of the fluorinated polymer. Water is added in order to obtain a paste, which is kneaded.

In a second step, the fluorinated polymer is incorporated into the paste. In a preferred embodiment of the invention, the fluorinated polymer is incorporated into the paste in the form of an aqueous solution. In order to obtain a plasticized positive electrode exhibiting good adhesion between the material and the support, the fluorinated polymer should be introduced separately from the other binders and at the end, in order to limit interactions with the other binders.

This paste is deposited on a current conductive support. The assembly formed by the paste deposited on the current collector is compressed. The electrode obtained is air dried at about 130° C.

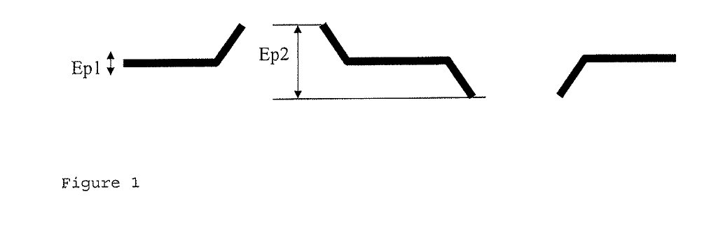

The current conductive support excludes metallic foam or felt. It can be a non-perforated or perforated foil, expanded metal, a grid the thickness of which is in general less than or equal to 100 μm. It can also be a perforated foil the thickness of which, in the non-perforated region, is less than or equal to 100 μm, and of which the peak-to-peak thickness in the perforation region is greater than the thickness in the non-perforated region (for example 200 μm). Such a foil is illustrated in FIG. 1, in which Ep1 represents the thickness of the support in the non-perforated region and Ep2 represents the peak-to-peak thickness of the support in the perforated region.

Preferably, a perforated nickel steel foil is employed, characterized by a thickness in the non-perforated region comprised between 20 and 100 μm, an area density comprised between 2 and 6 g/dm², a perforation rate comprised between 20 and 80%, and a perforation diameter of between 0.1 and 3 mm.

Still more preferably, a perforated nickel steel foil having a perforation rate comprised between 35 and 60%, and a perforation diameter comprised between 0.5 and 1.5 mm is employed.

Even more preferably, a perforated nickel steel foil having a perforation rate comprised between 45 and 55%, and a perforation diameter comprised between 0.9 and 1.2 mm is employed.

The invention also provides an alkaline secondary cell, for example of the NiCd or NiMH employing the non-sintered positive electrode described above and containing an electrolyte based on KOH and/or NaOH and/or LiOH and a separator based on untreated polyolefin fibers, or which have been treated by acrylic acid or sulfonated, or based on polyamide fibers.

The secondary cell can be of the cylindrical or prismatic type, open or sealed (valve-regulated), for portable or industrial applications (notably for automobile or safety lighting use).

### Examples

A plasticized positive electrode of the prior art (P1) was made using a paste having the following composition by weight:

| | |
|---|---|
| Electrochemically active material | 87.5% |
| Conductive material Co(OH)₂ | 10% |
| Polymer A (EVA) | 0.7% |
| Polymer C (CMC) | 0.3% |
| Polypropylene fibers | 1.0% |
| Y₂O₃ | 0.5% |

The electrochemically active material in powder form was constituted by a nickel-based hydroxide, containing the following additives: cobalt and zinc. The viscosity of the paste was adjusted with water. The paste was uniformly deposited simultaneously on both sides of a perforated nickel steel foil of 75 μm thickness. This assembly was then dried to drive out the water, and then rolled to the desired thickness and cut out in order to obtain a positive electrode. The finished electrode had a porosity of 35%, and 13 g of dry deposited material per dm².

A plasticized positive electrode of the prior art (P2) was made using a paste having the following composition by weight:

| | |
|---|---|
| Electrochemically active material | 85.5% |
| Conductive material Co(OH)₂ | 10% |
| Carboxylated SBR | 0.7% |
| Polymer B (PTFE) | 2.0% |
| Polymer C (CMC) | 0.3% |
| Polypropylene fibers | 1.0% |
| Y₂O₃ | 0.5% |

The electrochemically active material in powder form was made up of a nickel-based hydroxide, containing the following additives: cobalt and zinc. The viscosity of the paste was adjusted using water. The PTFE was introduced into the water at the end of the preparation of the paste. The paste was homogeneously deposited simultaneously on both faces of a perforated nickel steel foil of 75 μm thickness. This assembly was then dried in order to eliminate the water, then rolled to the desired thickness and cut out in order to obtain a positive electrode. The finished electrode had a porosity of 35% and 13 g of dry deposited material per dm².

A plasticized positive electrode of the prior art (P3) was made using a paste having the following composition by weight:

| | |
|---|---|
| Electrochemically active material | 87.3% |
| Conducting material Co(OH)₂ | 10% |
| Polymer A (PolyStyreneAcrylate) (PSA) | 0.9% |
| Polymer C (CMC) | 0.3% |
| Polypropylene fibers | 1.0% |
| Y₂O₃ | 0.5% |

The electrochemically active material in powder form was constituted by a nickel-based hydroxide, and containing the following additives: cobalt and zinc. The viscosity of the paste was adjusted using water. The paste was homogeneously deposited simultaneously on both faces of a perforated nickel steel foil of 75 μm thickness. The assembly was then dried in order to eliminate the water, then rolled to the desired thickness and cut out in order to obtain a positive electrode. The finished electrode had a porosity of 35% and 13 g of dry deposited material per dm².

A plasticized positive electrode outside of the scope of the invention (P4) was made with paste having the following composition by weight:

| | |
|---|---|
| Electrochemically active material | 87.6% |
| Conductive material Co(OH)₂ | 10% |
| Polymer A (EVA) | 0.7% |
| Polymer B (PTFE) | 0.4% |
| Polymer C (CMC) | 0.3% |
| Polypropylene fiber | 1.0% |
| Y₂O₃ | 0.5% |

The electrochemically active material in powder form was constituted by a nickel-based hydroxide containing the following additives: cobalt and zinc. The viscosity of the paste was adjusted using water. PTFE was introduced into the water at the end of the preparation of the paste. The paste was deposited homogeneously, simultaneously on both faces of a perforated nickel steel foil of 75 μm thickness. The assembly was then dried in order to eliminate the water, and then rolled to the desired thickness and cutout in order to obtain a positive electrode. The finished electrode had a porosity of 35% and 13 g of dry deposited material per dm².

A plasticized positive electrode outside of the scope of the invention (P5) was made with the paste having the following composition by weight:

| | |
|---|---|
| Electrochemically active material | 84.5% |
| Conductive material Co(OH)₂ | 10% |
| Polymer A (EVA) | 1.2% |
| Polymer B (PTFE) | 2.5% |
| Polymer C (CMC) | 0.3% |
| Polypropylene fibers | 1.0% |
| Y₂O₃ | 0.5% |

The electrochemically active material in powder form was constituted by a nickel-based hydroxide, containing the following additives: cobalt and zinc. The viscosity of the paste was adjusted using water. The PTFE was introduced into the water at the end of preparation of the paste. The paste was homogeneously deposited simultaneously on both faces of a perforated nickel steel foil of 75 μm thickness. The assembly was then dried in order to eliminate the water, then rolled to the desired thickness and cutout in order to obtain a positive electrode. The finished electrode had a porosity of 35% and 13 g of dry deposited material per dm².

A plasticized positive electrode outside the scope of the invention (P6) was made with a paste having the following composition by weight:

| | |
|---|---|
| Electrochemically active material | 83.0% |
| Conductive material Co(OH)₂ | 10% |
| Polymer A (EVA) | 0.7% |
| Polymer B (PTFE) | 4.5% |
| Polymer C (CMC) | 0.3% |
| Polypropylene fibers | 1.0% |
| Y₂O₃ | 0.5% |

The electrochemically active material in powder form was constituted by a nickel-based hydroxide, containing the following additives: cobalt and zinc. The viscosity of the paste was adjusted using water. The PTFE was introduced into the water at the end of preparation of the paste. The paste was homogeneously deposited simultaneously on both faces of a perforated nickel steel foil of 75 μm thickness. The assembly was then dried in order to eliminate the water, then rolled to the desired thickness and cutout in order to obtain a positive electrode. The finished electrode had a porosity of 35% and 13 g of dry deposited material per dm².

A plasticized positive electrode according to the invention (P7) was made using a paste having the following composition by weight:

| | |
|---|---|
| Electrochemically active material | 85.0% |
| Conductive material Co(OH)₂ | 10% |
| Polymer A (EVA) | 0.7% |
| Polymer B (PTFE) | 2.5% |
| Polymer C (CMC) | 0.3% |
| Polypropylene fibers | 1.0% |
| Y₂O₃ | 0.5% |

The electrochemically active material in powder form was constituted by a nickel-based hydroxide, containing the following additives: cobalt and zinc. The viscosity of the paste was adjusted using water. The PTFE was introduced into the water at the end of the preparation of the paste. The paste was homogeneously deposited simultaneously on both faces of a perforated nickel steel foil of 75 μm thickness. The assembly was then dried in order to eliminate the water, then rolled to the desired thickness and cutout in order to obtain a positive electrode. The finished electrode had a porosity of 35% and 13 g of dry deposited material per dm².

A plasticized positive electrode outside the scope of the invention (P8) was made using a paste having the following composition by weight:

| | |
|---|---|
| Electrochemically active material | 84.9% |
| Conductive material Co(OH)₂ | 10% |
| Polymer A (EVA) | 0.7% |
| Polymer B (PTFE) | 2.5% |
| Polymer C (CMC) | 0.4% |
| Polypropylene fibers | 1.0% |
| Y₂O₃ | 0.5% |

The electrochemically active material in powder form was constituted by a nickel-based hydroxide, containing the following additives: cobalt and zinc. The viscosity of the paste was adjusted using water. The PTFE was introduced into the water at the end of preparation of the paste. The paste was homogeneously deposited simultaneously on both faces of a perforated nickel steel foil of 75 μm thickness. The assembly was then dried in order to eliminate the water, then rolled to the desired thickness and cutout in order to obtain a positive electrode. The finished electrode had a porosity of 35% and 13 g of dry deposited material per dm².

A plasticized positive electrode outside the scope of the invention (P9) was made using a paste having the following composition by weight:

| | |
|---|---|
| Electrochemically active material | 85.0% |
| Conductive material Co(OH)₂ | 10% |
| Polymer A (EVA) | 0.7% |
| Polymer B (PTFE) | 2.5% |
| Polymer C (CMC) | 0.3% |
| Polypropylene fibers | 1.0% |
| Y₂O₃ | 0.5% |

The electrochemically active material in powder form was constituted by a nickel-based hydroxide, containing the following additives: cobalt and zinc. The viscosity of the paste was adjusted using water. The PTFE was introduced into the water simultaneously with the EVA at the beginning of preparation of the paste. The pace was homogeneously deposited simultaneously on both faces of a perforated nickel steel foil of 75 μm thickness. The assembly was then dried in order to eliminate the water, then rolled to the desired thickness and cutout in order to obtain a positive electrode. The finished electrode had a porosity of 35% and 13 g of dry deposited material per dm².

A plasticized positive electrode according to the invention (P10) was made using a paste having the following composition by weight:

| | |
|---|---|
| Electrochemically active material | 85.0% |
| Conductive material Co(OH)₂ | 10% |
| Polymer A (EVA) | 0.5% |
| Polymer B (PTFE) | 2.5% |
| Polymer C (CMC) | 0.3% |
| Polymer D (Silane) | 0.2% |
| Polypropylene fibers | 1.0% |
| Y₂O₃ | 0.5% |

The electrochemically active material in powder form was constituted by a nickel-based hydroxide, containing the following additives: cobalt and zinc. The viscosity of the paste was adjusted using water. The PTFE was introduced into the water at the end of preparation of the paste. The paste was homogeneously deposited simultaneously on both faces of a perforated nickel steel foil of 75 μm thickness. The assembly was then dried in order to eliminate the water, then rolled to the desired thickness and cutout in order to obtain a positive electrode. The finished electrode had a porosity of 35% and 13 g of dry deposited material per dm².

A plasticized positive electrode according to the invention (P11) was made using a paste having the following composition by weight:

| | |
|---|---|
| Electrochemically active material | 84.8% |
| Conductive material Co(OH)₂ | 10% |
| Polymer A (PSA) | 0.9% |
| Polymer B (PTFE) | 2.5% |
| Polymer C (CMC) | 0.3% |
| Polypropylene fibers | 1.0% |
| Y₂O₃ | 0.5% |

The electrochemically active material in powder form was constituted by a nickel-based hydroxide, containing the following additives: cobalt and zinc. The viscosity of the paste was adjusted using water. The PTFE was introduced into the water at the end of preparation of the paste. The paste was homogeneously deposited simultaneously on both faces of a perforated nickel steel foil of 75 μm thickness. The assembly was then dried in order to eliminate the water, then rolled to the desired thickness and cutout in order to obtain a positive electrode. The finished electrode had a porosity of 35% and 13 g of dry deposited material per dm².

### Mechanical Test

In order to be sure mechanical resistance of the electrodes was satisfactory, a drop test was performed as follows: each electrode was weighed and then released from a height of 50 cm on to a plane surface. Dropping was repeated 10 times. Then, the electrode was weighed again. The results of the test are expressed as the ratio of initial weight minus final weight to initial weight. Solidity of an electrode will be greater the smaller this ratio and when there is more than 0.5% loss of material in the drop test, the secondary cell is not a practical industrial proposition.

Sealed Cell Electrochemical Evaluation

A sealed secondary electrochemical NiCd cell of Cs format in which the positive electrode was the limiting electrode and having a nominal capacity of 1600 mAh consisted of the above-described positive electrodes and a negative electrode of a known type having a cadmium hydroxide as its electrochemically active material. The positive electrode was placed side by side with a negative electrode from which it was insulated by a non-woven polypropylene separator in order to form the electrochemical plate group. The spiral wound electrode plate group was inserted into a metal cup-like container and impregnated with an alkaline electrolyte which was an aqueous alkaline solution comprised of a mixture of 7.5N potassium hydroxide KOH, 0.4N sodium hydroxide NaOH and 0.5N lithium hydroxide LiOH, in order to constitute the secondary cells A to K. The composition of each of the secondary cells is given in tables 1 and 2.
Electrical Forming

After resting for 48 hours at ambient temperature, electrical forming of the secondary cells was performed under the following conditions:

Cycle 1:

2 hours resting at 80° C.

Charging with a current of 0.025 Ic for 8 hours at 80° C., where Ic is the current needed to discharge the nominal capacity C of the cell in 1 hour.

2 hours resting at 20° C.

3 hours charging at the current of 0.33 Ic.

Discharge at 0.2 Ic down to a voltage of 1V.

Electrical Performance.

After forming, secondary cell capacity was measured using the following cycles:

Cycles 2 to 4

16 hours charging at a current of 0.1 Ic.

Discharge at the current of 0.2 Ic down to a voltage of 1 V.

Following this, self-discharge at the initial state was measured using the following cycle:

Cycle 5:

16 hours charging at current of 0.1 Ic.

28 days resting at ambient temperature.

Discharge at Ic down to a voltage of 1V.

The initial self-discharge was calculated as a ratio of capacity measured at cycle 5 to the capacity measured at cycle 4.

Following this, the secondary cells underwent charging/discharge cycles at an elevated temperature of 55° C., which favored, firstly, positive electrode swelling and, secondly, a reaction leading to deterioration of the binders:

Cycles 6 to 56.

24 hours charging at a current of 0.05 Ic at 55° C.

Self-discharge at a current of Ic down to a voltage of 1 V at 55° C.

After 50 cycles, cell capacity was checked using the following cycle.

Cycle 57:

24 hours charging at a current of 0.05 Ic

discharge at a current of Ic down to a voltage of 1V.

Following this, self-discharge was measured again:

Cycle 58:

24 hours charging at a current of 0.05 Ic

28 days resting at ambient temperature

Discharge at a current of Ic down to a voltage of 1 V.

Loss of capacity by self discharge after ageing was calculated by the ratio between capacity measured at cycle 58 to the capacity measured at cycle 57.

TABLE 1
results obtained with positive prior art electrodes

| Secondary cell | A | B | C |
|---|---|---|---|
| Electrode | P1 | P2 | P3 |
| Support | foil | foil | foil |
| Polymer A (%) | 0.7 | 0.7 | 0.9 |
| | | carboxylated SBR | PSA |
| Polymer B (%) | 0 | 2.0 | 0 |
| Polymer C (%) | 0.3 | 0.3 | 0.3 |
| Polymer D (%) | 0 | 0 | 0 |
| Loss of matter (%) | 0.4 | 0.4 | 0.4 |
| Cycle 4 (mAh) | 1618 | 1592 | 1603 |
| Cycle 57 (mAh) | 1490 | 961 | 1458 |
| Loss//cycle 5 (%) | 8% | 40% | 9% |
| Cycle 58 | 100% | 23% | 71% |
| Self discharge (%) | | | |
| Incorporation of Polymer B | — | separately | — |
| simultaneously with or | | | |
| separately from the other | | | |
| constituents of the binder | | | |

TABLE 2
results obtained with compositions of binder in accordance with and not in accordance with the invention

| Secondary cell | D | E | F | G | H | J | K |
|---|---|---|---|---|---|---|---|
| Electrode | P4 | P5 | P6 | P7 | P8 | P10 | P11 |
| Support | foil | foil | foil | foil | foil | foil | foil |
| Polymer A (%) | 0.7 | 1.2 | 0.7 | 0.7 | 0.7 | 0.5 | 0.9 |
| | | | | | | | PSA |
| Polymer B (%) | 0.4 | 2.5 | 4.5 | 2.5 | 2.5 | 2.5 | 2.5 |
| Polymer C (%) | 0.3 | 0.3 | 0.3 | 0.3 | 0.4 | 0.3 | 0.3 |
| Polymer D (%) | 0 | 0 | 0 | 0 | 0 | 0.2 | 0 |
| Loss of material (%) | 0.4 | 0.3 | 0.3 | 0.4 | 0.4 | 0.3 | 0.4 |
| Cycle 5 (mAh) | 1612 | 1470 | 1450 | 1605 | 1605 | 1603 | 1595 |
| Cycle 57 (mAh) | 1480 | 1255 | 1334 | 1480 | 1412 | 1499 | 1459 |
| Loss//cycle 5 (%) | 8.1% | 14.6% | 8.0% | 7.8% | 12% | 6.3% | 8.5% |
| Cycle 58 | 58% | 26% | 22% | 27% | 23% | 22% | 22% |
| Self discharge (%) | | | | | | | |
| Incorporation of Polymer B | separately | separately | separately | separately | separately | separately | separately |
| simultaneously with or | | | | | | | |
| separately from the other | | | | | | | |
| constituents of the binder | | | | | | | |

The prior art plasticized positive electrodes P1, P2 and P3 perform well initially making it possible to provide cylindrical secondary cells on an industrial scale (less than 0.5% loss of material). Electrodes P1 and P3 exhibited a loss of capacity measured after 50 cycles of less than 10%. Nevertheless, self discharge of the secondary cells comprising electrodes P1 and P3 after 50 cycles at 55° C., that is after accelerated ageing was not satisfactory. Indeed, for P1 and P3 at cycle 58, self discharge rates of respectively 100% and 71% were measured. This can be explained by the presence of particles of positive active material which had migrated into the separator, introducing micro-short circuits. The storage cells B containing the prior art electrodes P2 had, after accelerated ageing, a loss of capacity by self discharge which was satisfactory, but their capacity at cycle 57 was 40% down on the value obtained at cycle 4. Indeed, the electrodes P2 contained a copolymer of styrene and butadiene which, under cycling conditions, breaks down more rapidly than ethylene and vinyl acetate copolymer or styrene and acrylate copolymer, which leads to more carbonates being generated which are detrimental to operation of the secondary cell.

The storage cells which included plasticized positive electrodes according to the invention, P7, P10 and P11 for which PTFE was added last while the paste was being produced, in an amount greater than 0.4% and less than 4%, exhibit a loss of capacity less than 9% and an improvement in self discharge under accelerated ageing conditions. Indeed, the self discharge rate for these secondary cells is comprised between 22 and 27%, which is satisfactory.

The secondary cells containing plasticized positive electrodes outside the scope of the invention, P5 and P6, which respectively included an amount of polymer a) greater than 1% and of polymer b) greater than 4%, exhibited insufficient capacity at cycle 5 (prior to ageing).

When the amount of carboxymethylcellulose (CMC) was greater than 0.3% (electrode P8), loss of capacity after accelerated ageing increased by 6.3% (P10) to 12%, the amount of carbonate generated being greater.

When the amount of PTFE is less than 0.5% (electrode P4), the amount of stable binder in the positive electrode is insufficient to avoid micro-short circuits, and self discharge increases (58%).

It will be seen from these results that a conventional foam positive electrode, thanks to its three-dimensional support, can be provided solely by using a thickener and PTFE whereas a plasticized positive electrode comprising solely PTFE and a thickener as the binder does not behave sufficiently well mechanically to support all the secondary cell production operations without significant loss of material.

It will also be seen that the steps of incorporating the constituents of the binder into the paste of a pasted electrode have an influence on the mechanical stability of the electrochemically active material to the current conductive support. When the PTFE is introduced at the beginning of paste production (P9), the latter develops interactions with the other binders, which deteriorates the cohesion of the material applied, with the result that industrial production of the electrodes is not a practical proposition. The drop test gives a value of 2.2%, which is well above the value of 0.5% employed as the criterion, as discussed above. Introducing PTFE into the paste of plasticized electrodes separately from the other constituents of the binder makes it possible to increase retention of the electrochemically active material on the current collector support. This is confirmed by a comparison of electrode P7 according to the invention which has an active material drop rate of 0.4% compared to electrode P9 which was outside the scope of the invention, and which exhibited a drop rate of 2.2%, the nature and proportions of the constituents of the binder being identical in both cases.

1. A non-sintered positive electrode for an alkaline secondary cell comprising a current conductive support and a paste comprising an electrochemically active material and a binder;
the binder comprising:
at least one polymer a) other than a fluorinated polymer or a thickener and containing at least one acrylate or acetate function, in a weight percentage less than or equal to 1% of the weight of the paste;
at least one fluorinated polymer b), in a weight percentage of from 0.5 to 4% of the weight of the paste;
at least one thickener c) in a weight percentage less than or equal to 0.3% of the weight of the paste.

2. The electrode according to claim 1, in which the weight percentage of polymer a) is from 0.1 to 1%, preferably from 0.3 to 0.9% of the weight of the paste.

3. The electrode according to claim 1, wherein the weight percentage of the fluorinated polymer b) is from 0.1 to 4%, preferably from 1 to 3% of the weight of the paste.

4. The electrode according to claim 1, in which the weight percentage of the thickener c) is from 0.01 to 0.3%, preferably from 0.05 to 0.25% of the weight of the paste.

5. The electrode according to claim 1, wherein the polymer a) is selected from the group comprising a copolymer of ethylene and vinyl acetate (EVA), a copolymer of styrene and acrylate, a polyacrylate, or a mixture thereof.

6. The electrode according to claim 5, wherein the polymer a) is selected from the group consisting of a copolymer of ethylene and vinyl acetate (EVA), a copolymer of styrene and acrylate, a polyacrylate, or a mixture thereof.

7. The electrode according to claim 1, wherein the fluorinated polymer is selected from the group comprising polytetrafluoroethylene (PTFE), a fluorinated ethylene/propylene (FEP) copolymer, hexafluoropropylene (HFP), or a mixture thereof.

8. The electrode according to claim 1, in which the thickener is cellulosic polymer selected from the group comprising carboxymethylcellulose (CMC), hydroxypropylmethylcellulose (HPMC), hydroxypropylcellulose (HPC), hydroxyethylcellulose (HEC), or is a polymer of the poly acrylic acid (PAAC) type or is a xanthane gum or a mixture thereof.

9. The electrode according to claim 1, further comprising silane of general formula X—Si(OR)₃,
R being selected from the group comprising methyl, ethyl, isopropyl, cyclohexyl or phenyl groups;
X being selected in the group comprising epoxy, amine, styrylamine, methacrylate, vinyl, chloroalkyl groups.

10. The electrode according to claim 9, in which R is a methyl group and X is an epoxy group.

11. The electrode according to claim 9, in which the silane is of the 3-glycidoxypropyltrimethoxy-silane type.

12. The electrode according to claim 9, in which the weight percentage of silane with respect to the weight of paste is less than 0.5%, preferably from 0.05 to 0.25%.

13. The electrode according to claim 1, in which the binder solely comprises:
a) a copolymer of ethylene and vinyl acetate (EVA), or a copolymer of styrene and acrylate, or a polyacrylate, or a mixture thereof;
b) a fluorinated polymer;
c) a thickener.

14. The electrode according to claim 1, in which the current conductive support is selected from the group comprising a non-perforated or perforated foil, an expanded metal, a grid.

15. The electrode according to claim 14, wherein the conducting support has a thickness, in the non-perforated region, less than about 0.1 mm.

16. The electrode according to claim 1, further including from 5 to 20% by weight of paste of a conductive material, preferably from 5 to 15% by weight of the paste.

17. The electrode according to claim 1, wherein the paste contains a compound based on yttrium, ytterbium, niobium or strontium.

18. The electrode according to claim 1, further including fibers.

19. An alkaline electrolyte secondary cell comprising an electrode according to claim 1.

20. A method for producing a non-sintered electrode comprising the steps of:
a) preparing a mixture comprising:
an electrochemically active material,
at least one polymer other than a fluorinated polymer or a thickener,
a thickener,
water;
b) forming a paste;
c) adding a fluorinated polymer to the paste obtained at step b);
d) depositing the paste obtained at step c) on a conductive support;
e) drying the electrode.

21. The method according to claim 20, in which the polymer of step a) other than a fluorinated polymer or a thickener, contains a least one acrylate or acetate function.

22. The method according to claim 20, in which in step c), the fluorinated polymer is added to the paste in the form of an aqueous solution.

23. The production method according to claim 20, in which the electrode is an electrode according to claim 1.
